(19) United States
(12) Patent Application Publication
(10) Pub. No.: US 2011/0102677 A1
(43) Pub. Date: May 5, 2011

(54) VIDEO RECEIVER AND DISPLAY OUTPUT METHOD

(76) Inventor: Tomohiro Kanda, Saitama-shi (JP)

(21) Appl. No.: 12/895,407

(22) Filed: Sep. 30, 2010

(30) Foreign Application Priority Data
Oct. 30, 2009 (JP) 2009-250727

(51) Int. Cl. H04N 5/445

(52) U.S. Cl. 348/563; 348/E05.096

(57) ABSTRACT

According to the embodiment, there is provided a video receiver including: an output module configured to output a display signal to a display device; an event notice receiver configured to receive an event notice indicating that predetermined information is receivable; a display form setting module configured to set a display form in which to display the predetermined information on the display device based on the event notice received by the event notice receiver; a display signal generator configured to generate a first display signal for displaying the predetermined information in the display form set by the display form setting module; a video information receiver configured to receive video information; and a video display signal generator for generating a second display signal for displaying an image on the display device based on the video information.

### CROSS-REFERENCE TO THE RELATED APPLICATION(S)

This application is based upon and claims the benefit of priority from prior Japanese Patent Application No. 2009-250727, filed on Oct. 30, 2009, the entire contents of which are incorporated herein by reference.

### BACKGROUND

1. Field

Embodiments described herein relate generally to a video receiver and a display output method, which allow a user to more easily recognize the importance of displayed information.

2. Description of the Related Art

With recent advancement of communications technologies, broadcast receivers have come to be provided, which are capable of receiving information other than a broadcast program and display the received information on a display device together with the broadcast program.

For example, a set-top box has been proposed which causes a display device to display a received broadcast program and information relating to it according to a format that is set by a broadcast provider.

### BRIEF DESCRIPTION OF THE DRAWINGS

A general configuration that implements the various features of the embodiments will be described with reference to the drawings. The drawings and the associated descriptions are provided to illustrate the embodiments and not to limit the scope of the invention.

FIG. 1 shows an example video display system according to a first embodiment.

FIG. 2 is a block diagram showing an example internal configuration of a DTV according to the first embodiment.

FIG. 3 is a block diagram showing an example internal configuration of the DTV that relates to an event display generating process according to the first embodiment.

FIG. 4 shows example displays which are displayed on a display unit of the DTV according to the first embodiment after reception of an event notice.

FIG. 5 shows an example display that is displayed on the display unit in the first embodiment when an event type of an event notice is “emergency.”

FIG. 6 shows an example display that is displayed on the display unit in the first embodiment when the event type of an event notice is “alert.”

FIG. 7 shows an example display that is displayed on the display unit in the first embodiment when the event type of an event notice is “notice.”

FIG. 8 shows an example display that is displayed on the display unit in the first embodiment when the event type of an event notice is “information.”

FIG. 9 is a flowchart of a process which is performed by the DTV according to the first embodiment after reception of an event notice.

FIG. 10 is a block diagram showing an example internal configuration of a DTV that relates to an event display generating process according to a modification of the first embodiment.

FIG. 11 shows example displays which are displayed on a display unit of the DIV according to the modification of the first embodiment after reception of an event notice.

FIG. 12 shows an example video display system according to a second embodiment.

FIG. 13 shows example displays which are displayed on a display unit of a DTV according to the second embodiment after reception of an event notice.

### DETAILED DESCRIPTION

According to the embodiments, there is provided a video receiver including: an output module configured to output a display signal to a display device; an event notice receiver configured to receive an event notice indicating that predetermined information is receivable; a display form setting module configured to set a display form in which to display the predetermined information on the display device based on the event notice received by the event notice receiver; a display signal generator configured to generate a first display signal for displaying the predetermined information in the display form set by the display form setting module; a video information receiver configured to receive video information; and a video display signal generator for generating a second display signal for displaying an image on the display device based on the video information.

There is also provided a display output method performed by a video receiver, the method including: receiving an event notice indicating that predetermined information is receivable from an external apparatus; setting a display form in which to display the predetermined information on a display device based on information contained in the received event notice; generating a first display signal for displaying the predetermined information in the display form being set; receiving video information; generating a second display signal for displaying an image on the display device based on the video information; and outputting the first and second display signals to the display device.

Embodiments will be described in detail with reference to the accompanying drawings. The scope of the claimed invention should not be limited to the examples illustrated in the drawings and those described below.

### First Embodiment

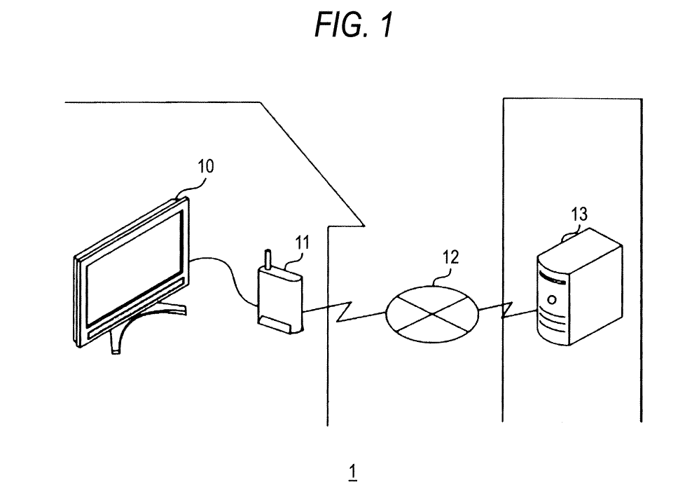

A first embodiment will be described below with reference to FIGS. 1-9.

FIG. 1 shows an example video display system 1 according to the first embodiment. As shown in FIG. 1, the video display system 1 is provided with a DTV 10, an HGW 11, the Internet 12, and a server 13.

The DTV 10 is a digital TV receiver which is an example video receiver according to the first embodiment. The DTV 10 has a function of receiving broadcast waves that are transmitted from a broadcasting station and displaying a broadcast program that is provided by the broadcasting station based on the received broadcast waves. Although in the first embodiment the DTV 10 will be described as an example video receiver, the video receiver may not be limited to the embodiments described below. The video receive may include a video reproducing apparatus such as an optical disc player having a tuner, a set-top box, and a cell phone.

The HGW 11 is a home gateway which has a function of connecting networks having different protocols in such a manner that they can communicate with each other. The DTV 10 and the Internet 12 are connected to the HGW 11, and the HGT 11 connects the DTV 10 and the Internet 12 in such a manner that they can communicate with each other. In the first embodiment, the HGW 11 and the DTV 10 are connected to each other by a LAN (local area network) cable. However, the HGW 11 and the DTV 10 may be connected to each other by another communication means such as a wireless LAN.

The Internet 12, which is a wide area network (WAN), allows various communication apparatus to be connected to one another and to communicate with each other.

The server 13, which is an information provider as an external apparatus, is capable to provide Web page information to the DTV 10. And the server 13 has a function of sending, by multicast, various event notices relating to pieces of provided information to electronic apparatus that are assigned a predetermined IP (Internet protocol) address.

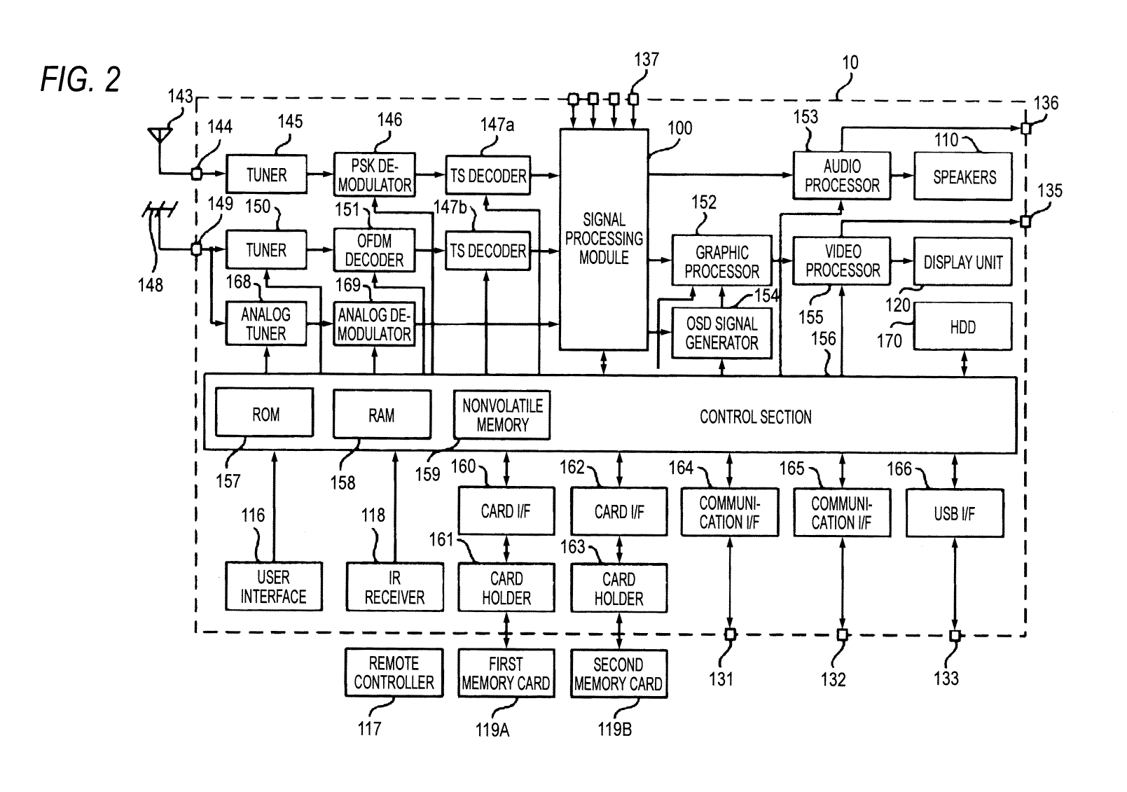

FIG. 2 is a block diagram showing an example internal configuration of the DTV 10 according to the first embodiment.

The DTV 10 is equipped with a controller 156 which controls other components provided in the DTV 10. The controller 156 may be a processor (CPU). The controller 156 activates a system control program and an appropriate one(s) of various processing programs that are stored in a ROM 157 in advance according to a operation command that is input from a user interface 116 or a operation command that is transmitted from a remote controller 117 and received by an IR receiver 118. The controller 156 controls other components provided in the DTV 10 using a RAM 158 as a work memory according to the activated programs. Various kinds of setting information, control information, etc. that are used for controlling the components are stored in a nonvolatile memory 159, for example.

For example, the DTV 10 is configured so as to be able to receive programs of various broadcast schemes such as the terrestrial analog broadcast, terrestrial digital broadcast, BS digital broadcast, and CS digital broadcast, and is equipped with an HDD 170 which can record not only programs that are transmitted by broadcasts of such broadcast schemes but also pieces of program-related information which are various kinds of information relating to the recorded programs.

A BS/CS digital broadcast receiving antenna 143 receives satellite digital broadcast signals (video information). The received digital broadcast signals are supplied to a satellite digital broadcast tuner 145 via an input terminal 144. The tuner 145 tunes in to one of the received digital broadcast signals and supplies the selected digital broadcast signal to a PSK (phase shift keying) demodulator 146. The PSK demodulator 146 demodulates a transport stream (TS) and supplies the demodulated transport stream to a TS decoder 147a. The TS decoder 147a decodes the transport stream into a digital video signal and audio signal and outputs the signals to a signal processor 100.

A terrestrial digital broadcast receiving antenna 148 receives terrestrial digital broadcast signals (video information). The received digital broadcast signals are supplied to a terrestrial digital broadcast tuner 150 via an input terminal 149. The tuner 149 tunes in to one of the received digital broadcast signals and supplies the selected digital broadcast signal to an OFDM (orthogonal frequency division multiplexing) demodulator 151. The OFDM demodulator 151 demodulates a transport stream (TS) and supplies the demodulated transport stream to a TS decoder 147b. The TS decoder 147b decodes the transport stream into a digital video signal and audio signal and outputs those to the signal processor 100.

The antenna 148 also receives terrestrial analog broadcast signals. The received terrestrial analog broadcast signals are divided by a distributor (not shown) and supplied to an analog tuner 168. The analog tuner 168 tunes in to one of the received analog broadcast signals and supplies the selected digital broadcast signal to an analog demodulator 169. The analog demodulator 169 demodulates the analog broadcast signal and outputs the demodulated analog broadcast signal to the signal processor 100. The DTV 10 also enables viewing of CATV (cable television) programs when, for example, a CATV tuner is connected to the input terminal 14 to which the antenna 148 is connected. The above-described antennas 143 and 148 serve as a video information receiver.

The signal processor 100 performs appropriate digital signal processing on each of digital broadcast signals that are output from the TS decoders 147a and 147b. Each digital broadcast signal is thereby divided into a data signal, a video signal, and an audio signal. The video signal and the audio signal are supplied to a graphic processor 152 and an audio processor 153, respectively. The signal processor 100 converts a broadcast signal that is output from the analog demodulator 169 into a video signal and an audio signal having predetermined digital formats. The digital video signal and audio signal are output to the graphic processor 152 and the audio processor 153, respectively. The signal processor 100 also performs predetermined digital signal processing on an input signal input through a line input terminal 137.

An OSD (on-screen display) signal generator 154 generates an OSD signal for display of a UI (user interface) screen under the control of the controller 156. The data signal that is separated from the digital broadcast signal by the signal processor 100 is converted by the OSD signal generator 154 into an OSD signal having an appropriate format, which is output to the graphic processor 152.

The graphic processor 152 performs decoding processing on the digital video signal that is output from the signal processor 100. The decoded video signal is combined with (overlapped on) the OSD signal that is output from the OSD signal generator 154, and a combined signal is output to a video processor 155. The graphic processor 152 selectively outputs the decoded video signal and the OSD signal to the video processor 155.

The video processor 155 converts the signal that is output from the graphic processor 152 into an analog video signal having such a format as to be displayable by a display unit (display device) 120. The analog video signal is output to the display unit 120 and displayed on its display screen. The video processor 155 can also output the video signal to an external apparatus such as an HDD recorder that is connected to an external output terminal 135.

The audio processor 153 converts the received audio signal into an analog audio signal having such a format as to be reproducible by speakers 110. The analog audio signal is reproduced by the speakers 110. The audio processor 153 can also output the analog signal to an external device such as an amplifier that is connected to an external output terminal 136.

A card holder 161 is connected to the controller 156 via a card interface (I/F) 160. A first memory card 119A can be inserted into the card I/F 160. The first memory card 119A is a storage medium such as an SD (secure digital) memory card, an MMC (multimedia card), or a CF (compact flash) card. The first memory card 119A that is inserted in the card holder 161 can exchange information with the controller 156 via the card I/F 120. The controller 156 stores image data, music data, a broadcast program, or the like in the first memory card 119A. Furthermore, the controller 156 reads image data, music data, a broadcast program, or the like from the first memory card 119A and displays the read data on the display unit 120 or output the read data from the speakers 110 as a sound.

A card holder 163 is connected to the controller 156 via a card I/F 162. A second memory card 119B may be inserted into the card I/F 162. The second memory card 119B is a storage medium for storing, for example, contract information of a broadcast reception contract. The first memory card 119B that is inserted in the card holder 163 exchanges information with the controller 156 via the card I/F 162.

A LAN terminal 131 is connected to the controller 156 via a communication I/F 164. The LAN terminal 131 is used as a common LAN-compatible port of Ethernet (registered trademark) and connected to the HGW 11 by a LAN cable. The LAN terminal 131 allows the DTV 10 to establish a communication connection with the Internet 12 via the HGW 11.

An HDMI (high-definition multimedia interface) terminal 132 is connected to the controller 156 via a communication I/F 165. The HDMI terminal 132 is used as a port for various electronic apparatus that comply with the common HDMI standard.

A USB (universal serial bus) terminal 133 is connected to the controller 156 via a USB I/F 166. The USB terminal 133 is used as a common USB-compatible port. A cell phone, a digital camera, a card reader/write for any of various memory cards, an HDD, a keyboard, or the like is connected to the USB terminal 133 via a hub, for example. The controller 156 exchanges information with a device that is connected to the USB terminal 133.

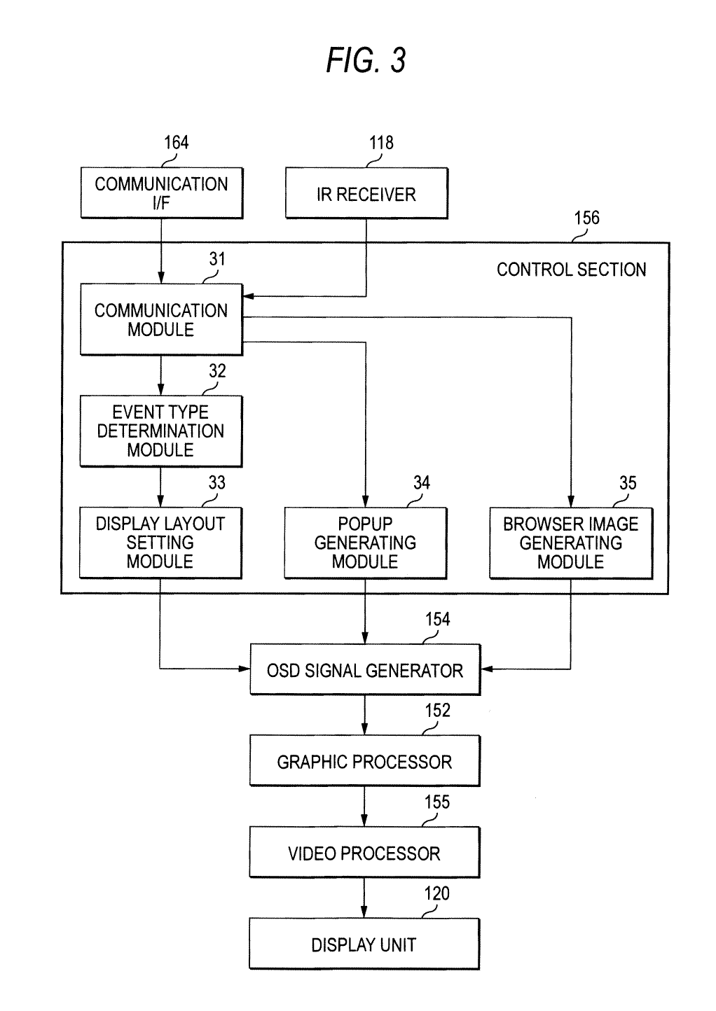

FIG. 3 is a block diagram showing an example internal configuration of the DTV 10 that relates to an event display generating process according to the first embodiment. As shown in FIG. 3, this part of the DTV 10 is provided with the communication I/F 164, the IR receiver 118, the controller 156, the OSD signal generator 154, the graphic processor 152, the video processor 155, and the display unit 120. The controller 156 includes of a communication module 31, an event type determination module 32, a display layout setting module 33, a pop-up generating module 34, and a browser image generating module 35.

The following description will be directed to a case that the server 13 has information to provide to the DTV 10 and sends, by multicast, an event notice for notifying the DTV 10 of presence of that information to apparatus having a predetermined IP address that include the DTV 10. When receiving the event notice, the DTV 10 displays a popup relating to the event notice. If the user sees the popup and wants to read information provided by the server 13, the DTV 10 acquires a Web page from the server 13 based on URL (uniform resource locator) information that is contained in the event notice according to an instruction from the user and displays the Web page using a predetermined browser which can deal with the Web page. In the first embodiment, the event notice contains event type information which indicates the importance of provided information of the event, a message which is a character string to be displayed in a popup generated by the DTV 10 for the event notice, a URL of a Web page containing the provided information, and other extension information.

The communication module 31 has a function of exchanging information with an external network via the communication I/F 164 by exchanging signals with the communication I/F 164. When receiving an event notice from the server 13 by serving as event notice receiver, the communication module 31 supplies information contained in the event notice to the event type determination module 32 and the popup generating module 34. The communication module 31 also has a function of supplying, later, the browser image generating module 35 with information relating to a Web page image to be received from the server 13. Furthermore, the communication module 31 has a function of receiving, via the IR receiver 118, a operation command of the user that is transmitted from the remote controller 117. The communication module 31 also has a function of supplying signals relating to a operation command to individual modules in the controller 156 that relate to the operation when receiving the operation command from the user.

The event type determination module 32 determines the event type of the event notice based on the information that is contained in the event notice and received from the communication module 31. The event type is an index which is communicated in advance by means of the event notice and indicates the importance and urgency of the information to be provided to the DTV 10 from the server 13. The event type has four types which are “emergency,” “alert,” “notice,” and “information,” and the importance and urgency lower in this order. The event notice contains event type information indicating one of those types, and the event type determination module 32 determines the event type based on the event type information. When determining the event type of the event information received by the DTV 10, the event type determination module 32 supplies information indicating the thus-determined event type to the display layout setting module 33.

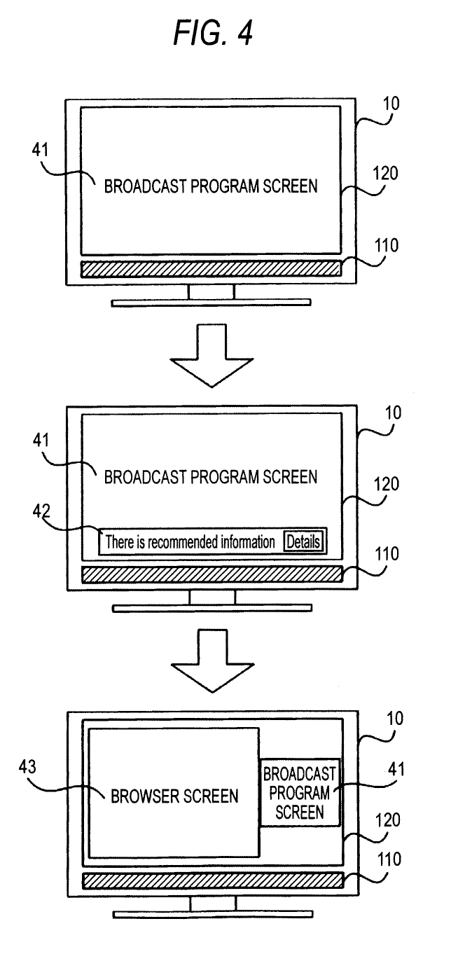

The display layout setting module 33 has a function of display form setting module which sets a display layout, on the display screen, of a display of a broadcast program being received and a browser screen of a Web page provided by the server 13 based on the information indicating the event type received from the event type determination module 32 when the user reads information of whose presence the DIV 10 is notified by the event notice (i.e., then the information is displayed on the DIV 10). Example layouts will be described later with reference to FIGS. 4-8.

The popup generating module 34 has a function of generating a signal of a popup for notifying the user of reception of an event notice based on information relating to the event notice that is received from the communication module 31 when the DTV 10 has received the event notice. The popup is an image which is overlapped on the display of a broadcast program and indicates that an event notice has been received and that the server 13 has information to provide. The user can acquire (read) that information by manipulate the remote controller 117 or the like according to an instruction in the popup image. Example popup images will be described later with reference to FIGS. 4-8.

The browser image generating module 35 has a function of receiving information relating to an image of a Web page provided by the server 13 that is received from the communication module 31 and generates display information of the Web page based on the received information. If the user sees the popup and operates the DTV 10 to have it display a Web page corresponding to the popup, the communication module 31 requests the server 13 to send information of the Web page to the DTV 10. If information of the Web page is transmitted from the server 10 in response to the request, the communication module 31 supplies this information to the browser image generating module 35. When receiving the information of the Web page, the browser image generating module 35 activates a browser and generates display information of the Web page together with the browser. In the first embodiment, the browser is an HTML (hypertext markup language) browser. However, the browser may be a BML (broadcast markup language) browser, a video image/still image viewer, or some other application execution environment.

In the first embodiment, when the display layout setting module 33, the popup generating module 34, and the browser image generating module 35 have generated display-related signals, those signals are supplied to the OSD signal generator 154. The OSD signal generator 154 generates an OSD signal based on the received display-related signals and outputs it to the graphic processor 152. When receiving the OSD signal, the graphic processor 152 (display signal generator) combines the OSD signal with the signal of a broadcast program being received and outputs a resulting combined signal (display signal) to the video processor 155. The video processor 155 (output module) outputs a combined image display signal to the display unit 120 based on the received signal.

Example displays which are displayed on the display unit 120 of the DTV 10 according to the first embodiment will be described below with reference to FIGS. 4-8.

FIG. 4 shows example displays which are displayed on the display unit 120 of the DTV 10 according to the first embodiment after reception of an event notice.

In this example, it is assumed that the user is viewing a broadcast program by the DTV 10 and the DIV 10 is displaying a broadcast program screen 41 over the entire screen of the display unit 120 (see the top part of FIG. 4). The broadcast program screen 41 is a displayed image of the broadcast program being received from a broadcasting station.

When the DTV 10 has received an event notice from the server 13, the DTV 10 generates a display image of a popup 42 and displays the popup 42 in such a manner that it is overlapped on the broadcast program screen 41 (see the middle part of FIG. 4). The display image of the popup 42 is generated based on a popup signal that is generated by the popup generating module 34.

If in this state the user makes an instruction not to display the popup 42 using the remote controller 117 or the like without making an instruction to read information provided from the server 13, the DTV 10 stops the display of the popup 42 and does nothing particular thereafter. In the embodiment, the popup 42 has a region with a word “details.” By selecting this region, the user can read the details of information provided from the server 13 (i.e., cause display of a Web page). If the user makes an instruction to display information provided from the server 13, the DTV 10 stops the display of the popup 42 and displays two images, that is, a reduced version of the broadcast program screen 41 which has been displayed so far and a browser screen 43 for displaying a Web page provided by the server 13 (see the bottom part of FIG. 4). The two screens are image displayed according to a layout that is generated by the layout setting module 33 based on the event type information contained in the event notice.

When the user has decided to read information provided from the server 13 at the sight of the popup 42, as described above the DTV 10 determines a layout of the broadcast program screen 41 and the browser screen 43 on the display unit 20 (i.e., their positions, sizes, presence/absence) based on the event type information contained in the event notice.

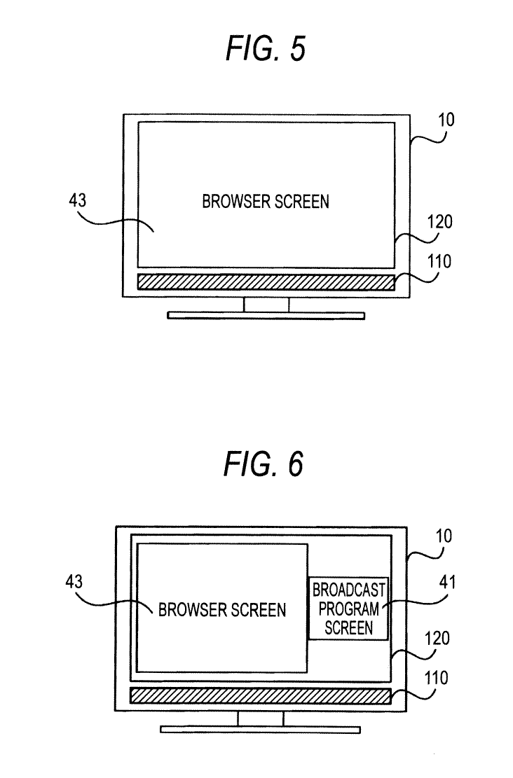

A corresponding relationship between the event type and the layout on the display unit 120 which is determined by the DTV 10 according to the embodiment will be described below with reference to FIGS. 5-8.

FIG. 5 shows an example display that is displayed on the display unit 120 in the first embodiment when the event type of the event notice is “emergency.”

In this example display, the broadcast program screen 41 is not displayed on the display unit 120 and the browser screen 43 is displayed over the entire screen of the display unit 120. When the event type information contained in the event notice that is transmitted from the server 13 is “emergency,” displaying the browser screen 43 over the entire screen of the display unit 120 allows the user to recognize, at a glance, that this Web page information is emergent information and hence is important. Furthermore, since the browser screen 43 is easier to see (more viewable), reading of the Web page is facilitated.

FIG. 6 shows an example display that is displayed on the display unit 120 in the first embodiment when the event type of the event notice is “alert.”

In this example display, the broadcast program screen 41 and the browser screen 43 are displayed on the display unit 120 in such a manner that the browser screen 43 is larger than the broadcast program screen 41. This allows the user to recognize, at a glance, that the information provided from the server 13 is important to some extent. Furthermore, since the browser screen 43 is large, the user can recognize the content of the Web page easily (visibility is high).

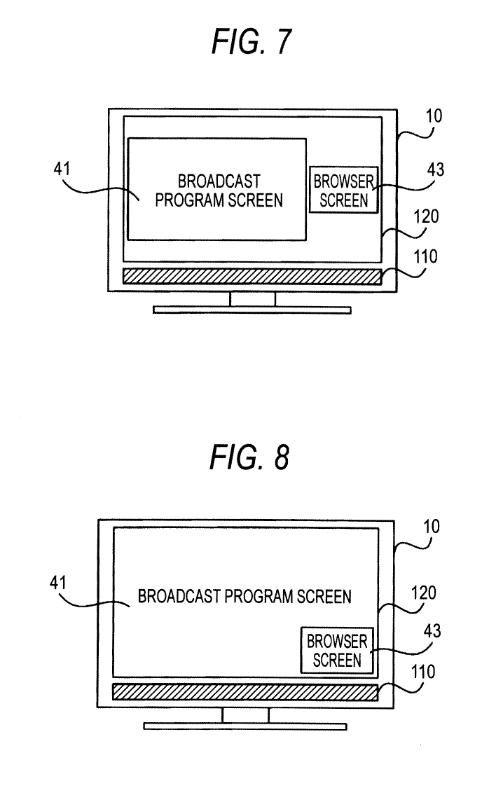

FIG. 7 shows an example display that is displayed on the display unit 120 in the first embodiment when the event type of the event notice is “notice.”

In this example display, the broadcast program screen 41 and the browser screen 43 are displayed on the display unit 120 in such a manner that the browser screen 43 is smaller than the broadcast program screen 41. This allows the user to recognize, at a glance, that the information provided from the server 13 is not very important.

FIG. 8 shows an example display that is displayed on the display unit 120 in the first embodiment when the event type of the event notice is “information.”

In this example display, the broadcast program screen 41 and the browser screen 43 are displayed on the display unit 120 in such a manner that the browser screen 43 is overlapped on the broadcast program screen 41 at a bottom-right position. This allows the user to recognize, at a glance, that the information provided from the server 13 is not important.

As described above, since the DTV 10 sets a layout of a broadcast program screen 41 and a browser screen 43 to be displayed on the display unit 120 based on the event type of an event notice received from the server 13, the user can recognize the importance and urgency of information provided from the server 13 merely by glancing at the layout of pictures including the browser screen 43 on the display unit 120. When the user is viewing the DTV 10, the provider side can timely provide emergent information such as “An earthquake will occur in 15 seconds” and the user can immediately recognize the importance of the information by checking the layout on the display unit 120. Furthermore, since a browser screen 43 of important information is displayed large, the user can recognize the information easily (a displayed Web page is easy to see).

The display layouts (display forms) of FIGS. 5-8 are just examples, and the display layout is not limited to them. The sizes, positions, etc. of the broadcast program screen 41 and the browser screen 43 can be set in various manners depending on the design. Whereas in the first embodiment the size and the position of the broadcast program screen 41 are varied, another layout mode is possible in which the broadcast program screen 41 continues to be displayed over the entire screen and the browser screen 43 is overlapped on the broadcast program screen 41. In this case, the DTV 10 changes the size of the browser screen 43 according to the event type of an event notice received. If the DTV 10 is designed so that the size of the browser screen 43 is increased as the importance that is indicated by the event type becomes higher, the user can recognize the importance of provided information at a glance by the size of the browser screen 43.

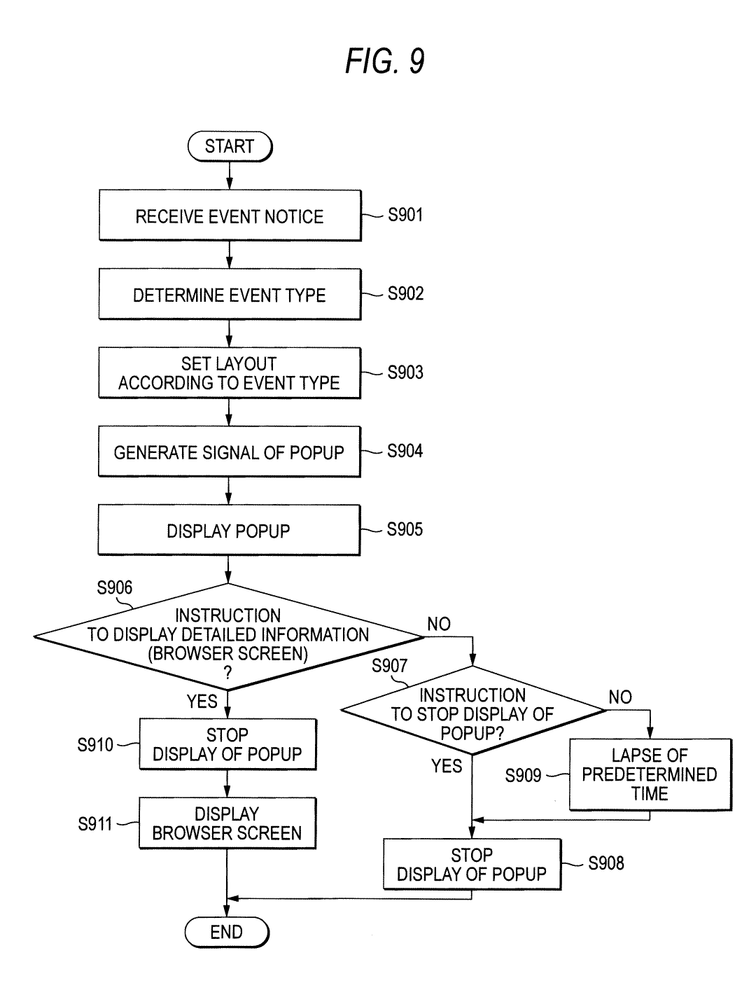

Next, a process which is executed by the DTV 10 according to the first embodiment after reception of an event notice will be described with reference to FIG. 9.

FIG. 9 is a flowchart of the process which is executed by the DTV 10 according to the embodiment after reception of an event notice.

When the DTC 10 receives an event notice via the LAN terminal 131 at step S901, at step S902 the event type determination module 32 determines an event type of the event notice.

At step S903, the display layout setting module 33 sets a layout of a broadcast program screen 41 and a browser screen 43 to be displayed on the display unit 120 according to the event type thus determined.

The popup generating module 34 generates a signal of a popup at step S904, and the DTV 10 displays a popup 42 on the display unit 120 based on the generated signal at step S905.

At step S906, the DTV 10 determines whether or not an instruction to display detailed information (a browser screen) has been received from the user. If determined that no such instruction has been received (S906: no), the DTV 10 at step S907 determines whether or not an instruction to stop the display of the popup image 42 has been received from the user. If determined that an instruction to stop the display of the popup image 42 has been received (S907: yes), the DTV 10 stops the display of the popup image 42. If determined that an instruction to stop the display of the popup image 42 has not been received (S907: no), the DTV 10 measures elapsed time with a built-in clock (not shown). When a predetermined time has elapsed (step S909), the DTV 10 moves to step S908, where the DTV 10 stops the display of the popup image 42.

If determined that an instruction to display detailed information has been received from the user (S906: yes), at step S911, the DTV 10 stops the display of the popup image 42 and displays a browser screen 43 and a broadcast program screen 41 according to the layout that was set at step S903 (in the first embodiment, the broadcast program screen 41 is not displayed if the event type is “emergency”). Example layouts of display on the display unit 120 are shown in FIGS. 5-8.

Upon execution of step S909 or S910, the process according to the first embodiment is finished.

In the first embodiment, the DTV 10 does not always display a popup as soon as an event notice is received. If the DTV 10 is displaying a popup 42 or a Web page corresponding to another event notice when receiving an event notice, the DTV 10 displays a popup corresponding to the event notice just received only if the importance indicated by the event type of this event notice is higher than (or equal to) that indicated by the event type of the event notice corresponding to the popup 42 or Web page being displayed. If the importance indicated by the event type of this event notice is lower than that indicated by the event type of the event notice corresponding to the popup 42 or Web page being displayed, the DTV 10 stores the information of the popup temporarily and displays the popup corresponding to the new, low-importance event notice when the display of the current popup 42 or Web page has been stopped. With this measure, the DTV 10 allows the user to preferentially view a screen that is higher in importance without displaying a less important screen corresponding to a later-received event notice.

In the first embodiment, the information source is the server 13 which is located outside the home of the user. However, the first embodiment may be configured to be adapted to an event notice that is received from any of household electrical appliances such as a door phone and a refrigerator that are connected to the DTV 10 via a home network (rather than the Internet 12) and the HGW 11. In this case, the DTV 10 may operate in the following manner. When receiving an event notice from the door phone, the DTC 10 displays a popup 42. If receiving an instruction to display detailed information from the user, the DTV 10 activates a viewer for displaying video of a scene as viewed from the door side that is received from the door phone system and displays that video. The event type of an event notice that is sent from the door phone system may be set according to the number of times the door phone bell button is pushed. When a door of the refrigerator is kept open, the refrigerator may send the DTV 10 an event notice whose event type depends on the time for which the refrigerator has been kept open.

In the DTV 10 according to the first embodiment, when an event notice is received and the user tries to view information that corresponds to the event notice and is provided by the server 13, the DTV 10 sets a display form of a browser screen according to the event type information that is contained in the event notice. In this manner, the display form of provided information can be set according to the provided information.

In the DTV 10 according to the first embodiment, a browser screen is displayed larger and hence is higher in visibility when the importance of information provided by the server 13 is high than when it is low.

### Modification of First Embodiment

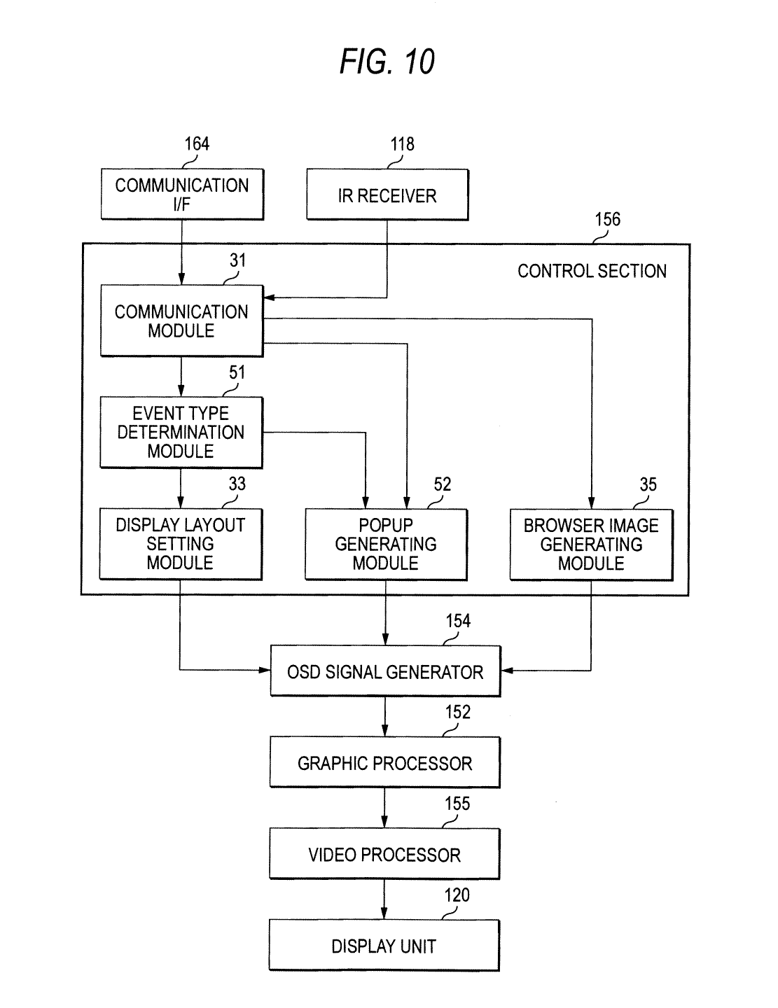

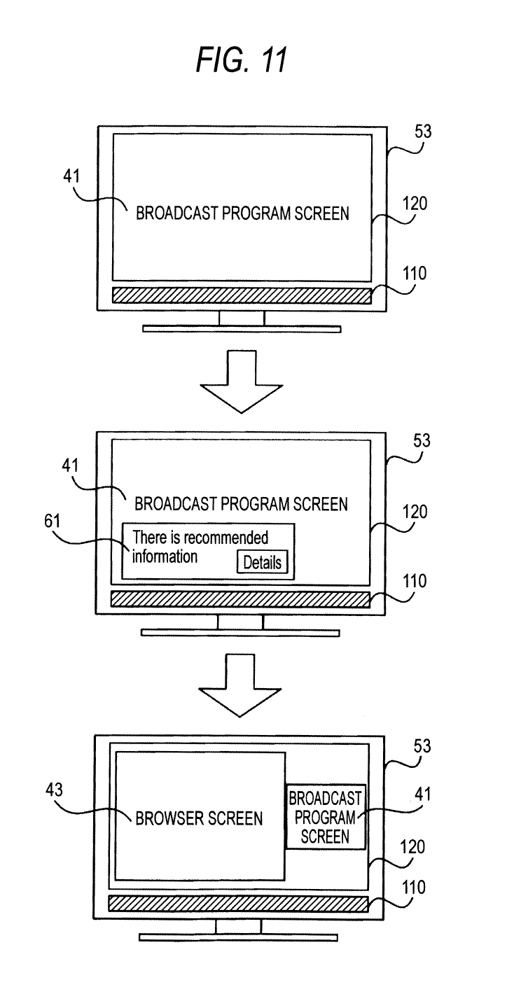

A modification of the first embodiment will be described below with reference to FIGS. 10 and 11.

The physical configuration of a video display system according to the modification is the same as the video display system 1 according to the first embodiment. Components having substantially the same functions as corresponding components in the first embodiment will be given the same reference numerals as the latter, and components having functions (or additional functions) different from corresponding components in the first embodiment will be given different reference numerals than the latter. In the modification, features that are different from the first embodiment will mainly be described and redundant descriptions will be avoided.

FIG. 10 is a block diagram showing an example internal configuration of a DTV 53 that relates to an event display generating process according to the modification. As shown in FIG. 10, this part of the DTV 53 is provided with the communication I/F 164, the IR receiver 118, the controller 156, the OSD signal generator 154, the graphic processor 152, the video processor 155, and the display unit 120. The controller 156 is provided with a communication module 31, an event type determination module 51, a display layout setting module 33, a pop-up generating module 52, and a browser image generating module 35.

After determining an event type of an event notice, the event type determination module 51 of the modification sends information indicating the event type to not only the display layout setting module 33 but also the popup generating module 52.

The popup generating module 52 has a function of setting a position and a shape of a popup based on the information indicating the event type received from the event type determination module 51 and generating a signal of a popup. An example position and shape of a popup that is set by the popup generating module 52 will be described below with reference to FIG. 11.

FIG. 11 shows example displays which are displayed on the display unit 120 of the DTV 53 according to the modification after reception of an event notice.

In the modified embodiment, the position and shape of the popup 61 are changed according to the event type information that is contained in an event notice received by the DTV 53. As shown in FIG. 11, the popup 61 is displayed at a position on the display unit 120 that corresponds to a position where a browser screen 43 will be displayed after an instruction to display a browser screen 43 is received. As shown in FIG. 11, the popup 61 is displayed at a left-hand position (as viewed from the user) on the display unit 120 like the browser screen 43 will be done later. Furthermore, the popup 61 has approximately the same length in the right-left direction as the browser screen 43. This allows the user to estimate the size of the browser screen 43 which will be displayed later. Since the popup 61 is displayed at the position that is close to the position where the browser screen will be displayed, even when the popup 61 is replaced by the browser screen 43, the user can see the browser screen 43 without the need for moving his or her line of sight. Thus, the user can see the browser screen 43 more easily.

### Second Embodiment

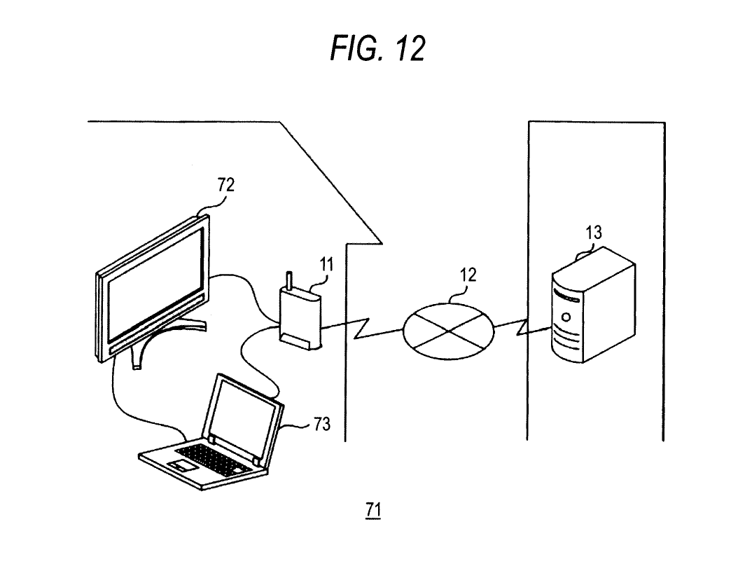

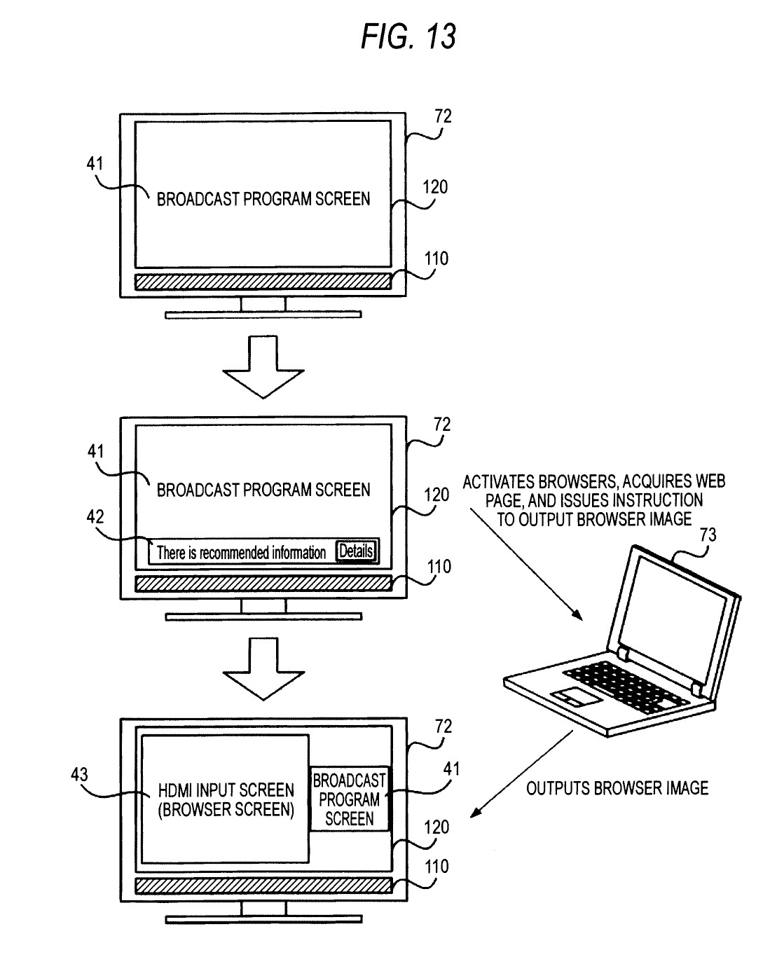

A second embodiment will be hereinafter described with reference to FIGS. 12 and 13.

As in the modification of the first embodiment, detailed description for the features that are also found in the first embodiment will be omitted in the following description.

FIG. 12 shows an example video display system 71 according to the second embodiment. As shown in FIG. 12, the video display system 71 is composed of a DTV 72, an HGW 11, a personal computer (PC) 73, the Internet 12, and a server 13.

In the second embodiment, the DTV 72 does not have a function of activating an HTML browser. The DTV 72 is connected to the PC 73 via the HDMI terminal 132 and an HDMI cable so as to be able to communicate with it. A communication using the HDMI cable is performed by using CEC (consumer electronics control) or HEC (HDMI Ethernet (registered trademark) channel).

The PC 73, which is an information processing apparatus capable of various kinds of information processing, is connected to the DTV 72 via the HDMI cable so as to be able to communicate with it, and is connected to the HGW 11 via a LAN cable so as to be able to communicate with it. Having a function of activating an HTML browser, the PC 73 can display a Web page received from the server 13 on a display device using the HTML browser.

FIG. 13 shows example displays which are displayed on the display unit 120 of the DTV 72 according to the second embodiment after reception of an event notice.

In the second embodiment, since the DTV 72 does not have a function of activating an HTML browser for displaying a Web page that is provided by the server 13, when receiving an instruction to display a browser screen (i.e., information provided by the server 13) from the user after displaying a popup 42, the DTV 72 instructs, via the HDMI cable, the PC 73 to acquire a Web page, activate the browser, and output a Web page image produced by the browser to the DTV 72. At this time, the DTV 72 sends URL information contained in an event notice to the PC 73, instructs the PC 73 to acquire the Web page from the server 13, and causes the PC 73 to activate the browser (in this embodiment, HTML browser) capable of developing the received Web page and output an image signal of the activated browser to the DTV 72. The DTV 72 displays an HDMI input screen (browser screen) 81 on the display unit 120 by combining the browser screen 81 (which is based on the signal received from the PC 73 via the HDMI terminal 132) with a broadcast program screen 41, for example, according to a layout that is set based on the event type information contained in the event notice.

The information contained in the event notice may be extended. Whereas in the second embodiment an event notice contains a message to be displayed as a popup by the DTV 73, a URL to be used for receiving provided information, and other information (extension information), the extension information may include browser-related information which relates to display by the browser. For example, the browser-related information is information relating to a display layout, information relating to a language for description of information provided by the server 13, various abilities of the browser, sizes of a browser screen etc., an enlargement/reduction factor, and other information. The DTV 72 may set a display form using the browser-related information which is set according to the importance information contained in the event notice. This measure allows the server 13 to request a display form of a browser screen with a high degree of freedom using the information contained in an event notice.

According to the second embodiment, even if the DTV 72 does not have a browser function for dealing with a file provided by the server 13, a browser screen can be displayed on the display unit 120 by receiving a signal of the browser screen via another electronic apparatus.

While certain embodiments have been described, these embodiments have been presented by way of example only, and are not intended to limit the scope of the invention. The novel method and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A video receiver comprising:
an output module configured to output a display signal to a display device;
an event notice receiver configured to receive an event notice indicating that predetermined information is receivable;
a display form setting module configured to set a display form in which to display the predetermined information on the display device based on the event notice received by the event notice receiver;
a display signal generator configured to generate a first display signal for displaying the predetermined information in the display form set by the display form setting module;
a video information receiver configured to receive video information; and
a video display signal generator for generating a second display signal for displaying an image on the display device based on the video information.

2. The video receiver of claim 1,
wherein the display form setting module is configured to sets a display form of the video information based on the event notice, and
wherein the output module is configured to output the video signal in accordance with the display form of the video information set by the display form setting module.

3. The video receiver of claim 1 further comprising:
an event type determining module configured to determine an event type that is contained in the event notice and to indicate importance of the predetermined information,
wherein the display form setting module is configured to set a display form of the predetermined information based on the event type determined by the event type determining module.

4. The video receiver of claim 3,
wherein the display form setting module is configured to set a display form of the predetermined information so that the predetermined information is displayed with a larger display size when the event type indicates that the predetermined information is high in importance than when the event type indicates that the predetermined information is low in importance.

5. The video receiver of claim 1 further comprising:
a popup display signal output module configured to set a display form of a popup indicating reception of the event notice, to generate a display signal of the popup according to the display form being set, and to output the popup display signal to the display device when the event notice receiver receives the event notice.

6. The video receiver of claim 1 further comprising:
a transmitting module configured to request an external apparatus to receive the predetermined information and to send the predetermined information; and
a receiving module configured to receive the predetermined information sent from the external apparatus.

7. A display output method performed by a video receiver, the method comprising:
receiving an event notice indicating that predetermined information is receivable from an external apparatus;
setting a display form in which to display the predetermined information on a display device based on information contained in the received event notice;
generating a first display signal for displaying the predetermined information in the display form being set;
receiving video information;
generating a second display signal for displaying an image on the display device based on the video information; and
outputting the first and second display signals to the display device.
